(19) United States
(12) Patent Application Publication
(10) Pub. No.: US 2019/0147033 A1
(43) Pub. Date: May 16, 2019

(54) SYSTEM AND METHOD FOR CREATING, FORMATTING AND TEMPLATING DESCRIPTIONS OF ONLINE PRODUCTS, ITEMS OR SERVICES

(71) Applicant: Amanda J Morse, Phoenix, AZ (US)

(72) Inventor: Amanda J Morse, Phoenix, AZ (US)

(21) Appl. No.: 16/191,513

(22) Filed: Nov. 15, 2018

Related U.S. Application Data
(60) Provisional application No. 62/586,297, filed on Nov. 15, 2017.

(51) Int. Cl. G06F 17/24; G06Q 30/06; G06F 17/21

(52) U.S. Cl. CPC G06F 17/248; G06F 17/212; G06F 17/243; G06Q 30/0603

(57) ABSTRACT

A system and method for automatically generating descriptions of online products, items or services, is disclosed. The system is configured to receive information from the user via the user device, wherein the information comprises at least one of a product information, a service information or an information requiring description. The system further provides a template form respective to the received information from the user for gathering data. Further, the system converts the gathered data from the user into an expanded readable description, and presenting the expanded readable description. Further, the description of the item or product generated automatically by the system would save the user time and money.

### CROSS REFERENCE TO RELATED APPLICATION

The present application claims the benefit of U.S. Patent Application No. 62/586,297 filed Nov. 15, 2017, the contents of which is hereby incorporated by reference.

### BACKGROUND OF THE INVENTION

### A. Technical Field

The present invention generally relates to a system and method for generating a product description. Specifically, the present invention relates to a system and method for automatically generating descriptions of online products, items or services.

### B. Description of Related Art

Various websites and other programs or applications allow users to advertise products, items or services online. Such items may be listed or posted for sale or simply to provide information and/or description of the items depending on the application or the website. Many existing tools provided for posting or listing items may utilize multiple steps in multiple pages while information and data are being gathered. Users are typically also required to categorize the items being bought based on a category that best matches what it is they are buying.

Existing listing techniques list or post the products or items and information online, from services, software, and applications to platforms. Nearly all of them have a form with blank fields where the user enters the information or data such as price, title, quantity, etc. There is also typically a larger blank field, area or box where a longer description of a product could be entered, this is typically called “Description”, but may also be shown under different headers such as “More about this item”, “Describe your item”, etc. The description field or box referenced above is filled in by the user with any supplemental or supporting information that is typically written by the user in prose, but also may allow formatting such as adding bullet points, lists, bold, italic or underline to text, graphic design features, videos and or images that present the description in an easy to read and pleasing way. The benefits of adding content to the description box as referenced above become obvious when considering the keyword rich nature which is better for search engine optimization commonly known as SEO, and also because readers of that online listing benefit from a better understanding of the product or service being described.

In addition, if a user is listing a pre-owned t-shirt for sale online using a standard online listing form, there might be fields and/or pre-defined attribute choices to enter the title, size, color, material, along with the blank description box where more information could be included about the item. For example, if the color of the t-shirt is aqua but the closest available pre-defined attribute choices for color are blue or green, there is no good way to describe this with the standard attribute fields unless the specific aqua color information is added to the description box. People may also be more likely purchase an item based on the content added to the description box rather than the attributes, because they may want to know the story behind that item or product, why and/or how the item was made, what makes the item useful to the buyer, etc.

Adding additional information in the description box is often the most difficult and time-consuming part of creating an online listing for the user. A blank description box becomes very complicated and time-consuming for all this added information without some kind of structure or easy way to input this data. In addition, to make it easier to fill out a blank description box, some users create separate listing templates that may be copied/pasted into the description box. Often the user needs to manually delete unrelated information left from the template, and this could lead to mistake and errors in listings.

A prior art, U.S. Pat. No. 7,840,448 discloses a system and method for automatically generating a naturally reading narrative product summary including assertions about a selected product. The method includes various steps of determining an attribute associated with the selected product, retrieving an assertion model defining forms in which an assertion could be manifested to describe the product in a natural manner, and generating a naturally reading narrative by combining the attribute with the retrieved assertion model. However, this system and method have some drawbacks and it uses predefined written descriptions with custom attributes to generate a naturally reading narrative product summary. This system lacks to enable the user to modify the generated product summary at any point of time by adjusting or changing the inputs in the form via the computing device. The only way the user can adjust the generated description is manually after the summary was automatically generated, in this case the system would override their entries if the summaries were automatically re-generated by the system later on, which is a major drawback.

The other prior art, U.S. Pat. No. 8,719,075 discloses a system and method which enables users to buy and sell items in an online marketplace. To list the item on an online marketplace website, for example, the selling user posts an item with the marketplace website by completing an online-item creation form. The form requires input related to the item, such as a description, sale price or minimum bid, shipping instructions, and the like. The selling user could also upload an image file of the item to the marketplace website's server. However, this patent mainly focuses on user uploaded image files with the system automatically generating alternate sizes of image files and inserting them in the description. This system and method lack to disclose how it would automatically generate a complete description or information of the items or products for the users or sellers to include text, video files, and other media types. Further, this patent lacks to address how the description area would be generated for some websites which do not allow images in the description, for example, but not limited to, an Etsy website.

The other prior art, U.S. Pat. No. 9,589,228 discloses a system and method for creating and revising information objects, such as proposed storylines, product descriptions, etc. The system uses a computational linguistics program and artificial-artificial intelligence (AAI) to generate an information of the object. However, the system is more complicated to create the product description, and instead of assisting the user with description formatting and creation, it focuses on revising a pre-written description, and a description would be created using computational linguistics program and artificial-artificial intelligence (AAI), where there was none before is unclear. Further, this system lacks to enable the user to manually modify the generated product summary at any point of time by adjusting or changing the inputs in the form via the computing device.

Accordingly, there is a need for a new system and method for generating, forming and creating a description of items or products in the description box(es) and services in the online marketplace, classifieds and other by taking inputs from the user. The description of items is programmatically formatted and completed using a form or questionnaire with specific item details given by the user. The new system also adapts that description or content to the online channel and it will be published on. Further, the system facilitates the users or sellers to complete item listings in as little time as possible, since their profits will rely on the quantity of listings they can produce, the quality these listings have, and/or a combination of both.

### SUMMARY OF THE INVENTION

The present invention generally discloses a system and method for generating a product description. The present invention further discloses a system and method for automatically generating descriptions of online products, items or services.

In an embodiment, a system for creating a description for an information provided by a user is disclosed. The system comprises, a computing device with a processor and a memory unit, a database in communication with the computing device for storing information related to a plurality of products and services, and a user device associated with the user configured to access the computing device via a network. In one embodiment, the memory unit stores a set of program modules, and the processor in communication with the memory unit, configured to execute the set of program modules. In one embodiment, the set of program modules comprises an input module, a form creation module, a description generation module and an output module. In one embodiment, the input module is configured to receive the information from the user via the user device. The information comprises at least one of a product information, a service information or an information requiring description. In one embodiment, the form creation module is configured to present at least one of a form or a template form respective of the received information to the user for gathering data. In one embodiment, the description generation module is configured to convert the gathered data into an expanded readable description, and an output module is configured to present the expanded readable description to the user via the user device.

In another embodiment, a method for creating a description for an information provided by a user is disclosed. The method is incorporated in the system comprising a computing device with a processor and a memory unit, a database in communication with the computing device for storing a plurality of products and services related information, and a user device. The user device is configured to access the computing device via a network. The method comprises the steps of (a) receiving at the processor, via an input module, the information from the user via the user device, wherein the information comprises at least one of a product information, a service information or an information requiring description, (b) presenting at the processor, via a form creation module, at least one of a form or a template form respective of the received information to the user for gathering data, (c) converting at the processor, via a description generation module, the gathered data into an expanded readable description, and (d) presenting at the processor, via an output module, the expanded readable description to the user via the user device.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The embodiments herein will be better understood from the following detailed description with reference to the drawings, in which:

FIG. 1 shows a block diagram of an environment implemented in accordance with various embodiments of the present invention.

FIG. 2 shows a block diagram of the server of the description generating system in an embodiment of the present invention.

FIG. 3 shows a flowchart of a method for creating the item description in one embodiment of the present invention.

FIG. 4 shows a flowchart of a process for creating the item description in one embodiment of the present invention.

FIG. 5A-5C shows a screenshot of an example form of a product or item in one embodiment of the present invention.

FIG. 6A shows a screenshot of a web page includes a plurality of items with the form in an embodiment of the present invention.

FIG. 6B shows a screenshot of a web page includes a plurality of items with the form in one embodiment of the present invention.

FIG. 7A shows a screenshot of taking measurements of a cloth or jacket with a shoulder seam in one embodiment of the present invention.

FIG. 7B shows a screenshot of taking measurements of a cloth or jacket without a shoulder seam in one embodiment of the present invention.

FIG. 8 shows a screenshot or snippet of form elements and renderings in description fields in one embodiment of the present invention.

FIG. 9 shows a screenshot of example form elements and renderings in description fields in one embodiment of the present invention.

FIG. 10A shows a screenshot of an empty product short description section of a website in one embodiment of the present invention.

FIG. 10B shows a screenshot of a product or jacket description section in one embodiment of the present invention.

FIG. 11A shows a screenshot of an empty product long description section of a website in one embodiment of the present invention.

FIG. 11B shows a screenshot of a long description of a product in one embodiment of the present invention.

FIG. 12A shows a screenshot of an empty description section or box of the item or product with html markup option of an eBay listing form in one embodiment of the present invention.

FIG. 12B shows a screenshot of a description section or box of the item or product with html markup option of an eBay listing form in one embodiment of the present invention.

FIG. 13A shows a screenshot of an empty etsy description section of the product in one embodiment of the present invention.

FIG. 13B shows a screenshot of the etsy description generated by the system in one embodiment of the present invention.

FIG. 14A-14B shows a screenshot of a template form in one embodiment of the present invention.

FIG. 15 shows a screenshot of finding and customizing templates by a user in one embodiment of the present invention.

FIG. 16 shows a screenshot of template select option in one embodiment of the present invention.

FIG. 17 shows a screenshot of a template create option in one embodiment of the present invention.

FIG. 18 shows a screenshot of a list of an item form with images and/or text in one embodiment of the present invention.

FIG. 19 shows a screenshot of an example form for women's shorts in one embodiment of the present invention.

FIG. 20 shows a screenshot of an example of a form for a men's t-shirt in one embodiment of the present invention.

FIG. 21A shows a screenshot of a spreadsheet type data file contains multiple fields in one embodiment of the present invention.

FIG. 21B shows a screenshot of a product description in one embodiment of the present invention.

FIG. 21C shows a screenshot of a completed spreadsheet of the item description with html markup in one embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

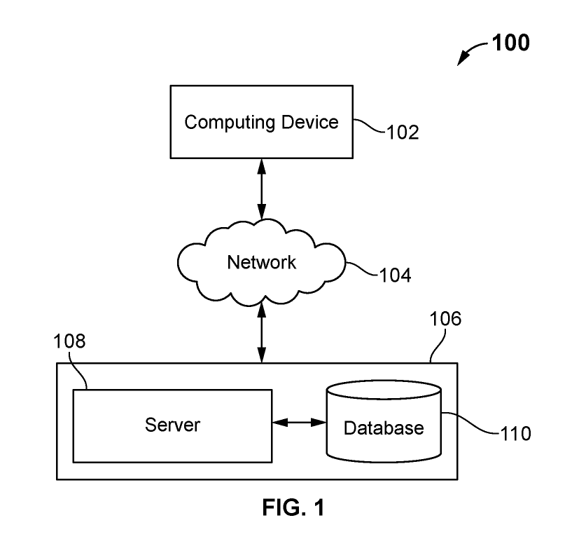

The present invention discloses a system and method to generate an online product description. The system enables a user to choose a particular type of products or items, for example, shoes or clothes, via a web page, in a computing device. The system further enables the user to give inputs via the computing device for generating a description of the online product or item. Referring to FIG. 1, a block diagram of an environment 100 implemented in accordance with various embodiments of the present invention is disclosed. The environment 100 comprises a user device 102, a network 104, and a description generating system 106. In an embodiment, the system 106 comprises a server 108 and at least one database 110.

In an embodiment, the user device 102 is enabled to access the system 106 via the network 104 to create the description of the online product or item based on the user's inputs. In an embodiment, the user could be a seller, a buyer, a wholesaler, a retailer, a trader, or an end-customer. The server 108 is configured to evaluate the item or product based on the user's selection and the input. In an embodiment, the user device 102 is at least one of a desktop, a laptop, a tablet, a mobile phone, and mobile and/or handheld electronic devices. In an embodiment, the user device 102 is in communication with the network 104 to access the server 108. In an embodiment, the network 104 could be Wi-Fi network, WiMax network, and wireless local area network.

In one embodiment, at least one database 110 may be accessible by the server 108. The database 110 may be integrated into the server 108 or separate from it. In some embodiments, the database 110 resides in a connected server or in a cloud computing service. Regardless of location, the database 110 comprises a memory to store and organize certain data for use by the server 108. In some embodiments, the database stores plurality of items or products and services related information and an algorithm or a code. The item or product related information includes type of item, manufacturing details, market price or average market price, item details, and other specifications related to the item.

In one embodiment, the server 108 is at least one of a general or special purpose computer. The server 108 could be operated as a single computer, which can be a hardware and/or software server, a workstation, a desktop, a laptop, a tablet, a mobile phone, a mainframe, a supercomputer, a server farm, and so forth. In some embodiments, the computer could be touchscreen and/or non-touchscreen and adapted to run on any type of OS, such as iOS™, Windows™, Android™, Unix™, Linux™ and/or others. In one embodiment, the plurality of computers is in communication with each other, via networks. Such communication can be via a software application, a mobile app, a browser, an OS, and/or any combination thereof.

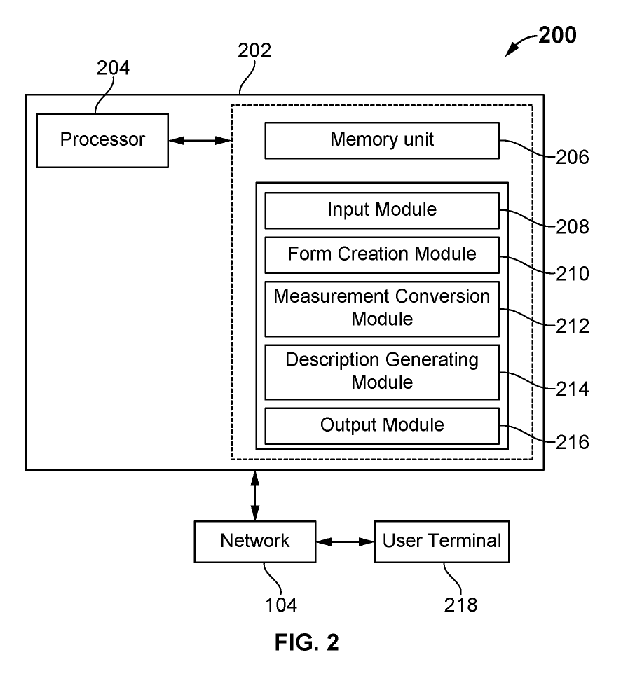

Referring to FIG. 2, the block diagram 200 of the server 202 of the description generating system 106 (shown in FIG. 1) is illustrated. The server 202 comprises a processor 204 and a memory unit 206. The memory unit 206 comprises a set of program modules comprises an input module 208, a form creation module 210, a measurement conversion module 212, a description generating module 214, and an output module 216. In one embodiment, the user accesses the server 202 via the computing device 218 via the network 104. In some embodiments, the computing device or user terminal 218 is at least anyone of a desktop, a laptop, a tablet, a mobile phone, mobile and/or handheld electronic devices, personal digital assistants, smart phones, smart televisions, palm tops, and speech-generating devices (SGDs) such as echo devices include, but not limited to, Amazon Alexa.

In one embodiment, the server 202 is configured to evaluate the item based on the user's selection and input. The input module 208, executed by the processor 204, is configured to receive input data related to particular type of item or service selected by the user. The form creation module 210, executed by the processor 204, configured to provide a form or questionnaire based on the selection of the item by the user via the display. The measurement conversion module 212, executed by the processor 204, configured to convert measurements in an imperial to the metric system. The description generating module 214, executed by the processor 204, configured to generate description of the item based on the input given by the user via the form or questionnaire. The output module 216, executed by the processor 204, configured to display the description of the item in the form or questionnaire generated by the description generating module via the computing device or user terminal 218.

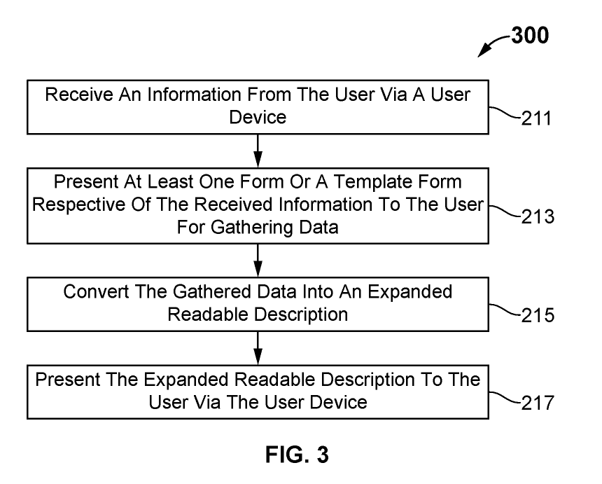

Referring to FIG. 3, the flowchart 300 of a method for creating the item description according to the present invention is illustrated. The method comprises the steps of: at step 211, receive the information from the user via the user device via an input module 208 (shown in FIG. 2). The information comprises at least one of a product information, a service information or an information requiring description. At step 213, present at least one of a form or a template form respective of the received information to the user for gathering data via the form creation module 210 (shown in FIG. 2). At step 215, convert the gathered data into an expanded readable description by the processor via the description generation module 214 (shown in FIG. 2). Further step 217, present the expanded readable description to the user via the user device via the output module 216 (shown in FIG. 2).

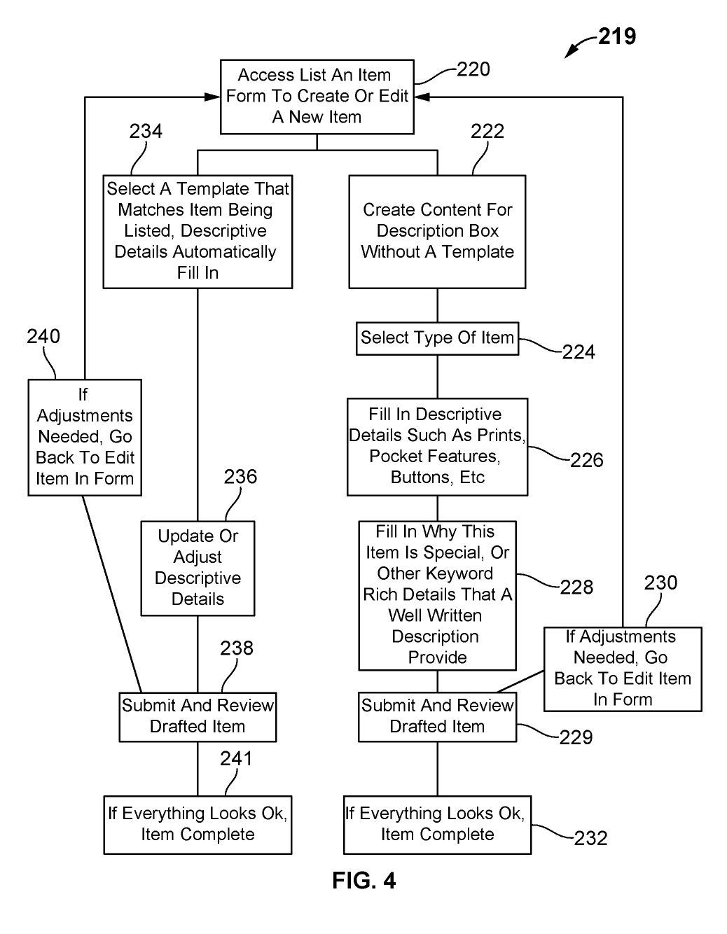

Referring to FIG. 4, the flowchart 219 of a process for creating the item description according to the present invention is illustrated. At step 220, the user could access a plurality of items or products via the server 202 (shown in FIG. 2), through the computing device 218 (shown in FIG. 2). At step 222, the user could select the option for generating description of the item without using template. In one embodiment, the item or product description could be generated without using templates of the plurality of the items. A general form could be displayed with questions applicable to any item, service or type. At step 224, the user could select at least one item from the plurality of items accessed by the server 202 (shown in FIG. 2) via the computing device 218 (shown in FIG. 2). After selection, the system 106 (shown in FIG. 2) could generate a more specific form or questionnaire for the user based on the option selected. At step 226, the user could fill the form and respond to the questions, for example, jacket prints, pocket features, buttons, etc. At step 228, the user could also specify the details, for example, specialty of the jacket, or using other keywords to fill the form or questionnaire. In one embodiment, the system 106 (shown in FIG. 2) could generate or create a detailed description of the item or product based on the user's input given via the form. At step 229, the user could submit and review the drafted items via the computing device 218 (shown in FIG. 2). At step 230, if any modifications or adjustments are needed in the description, the user could go back to edit the form via the computing device 218 (shown in FIG. 2). At step 232, the process is completed once the user satisfied with the description generated by the system 106 (shown in FIG. 2).

In another embodiment, the system 106 could also generate a template according to the selection of the item or service by the user. At step 234, the user could select the option for generating description of the item by using template. In one embodiment, the system 106 (shown in FIG. 2) could generate a template that matches the item being listed, descriptive details automatically fill in. At step 236, the user could respond to the template and update the details of the items in the template. In one embodiment, the system 106 (shown in FIG. 2) could generate or create the detailed description of the item or product based on the user's input given via the template. At step 238, the user could submit and review the drafted items via the computing device 218 (shown in FIG. 2). At step 240, if any modifications or adjustments are needed in the description, the user could go back to edit the template via the computing device 218 (shown in FIG. 2). At step 241, the process is completed once the user satisfied with the description generated by the system 106 (shown in FIG. 2).

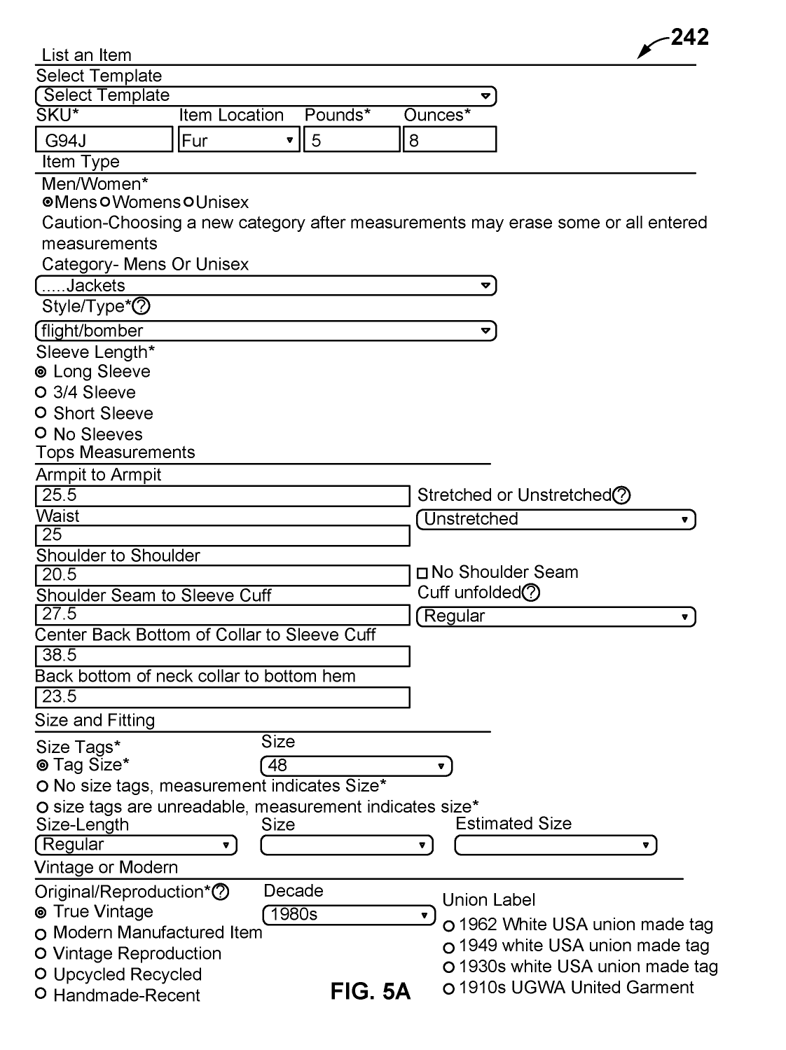

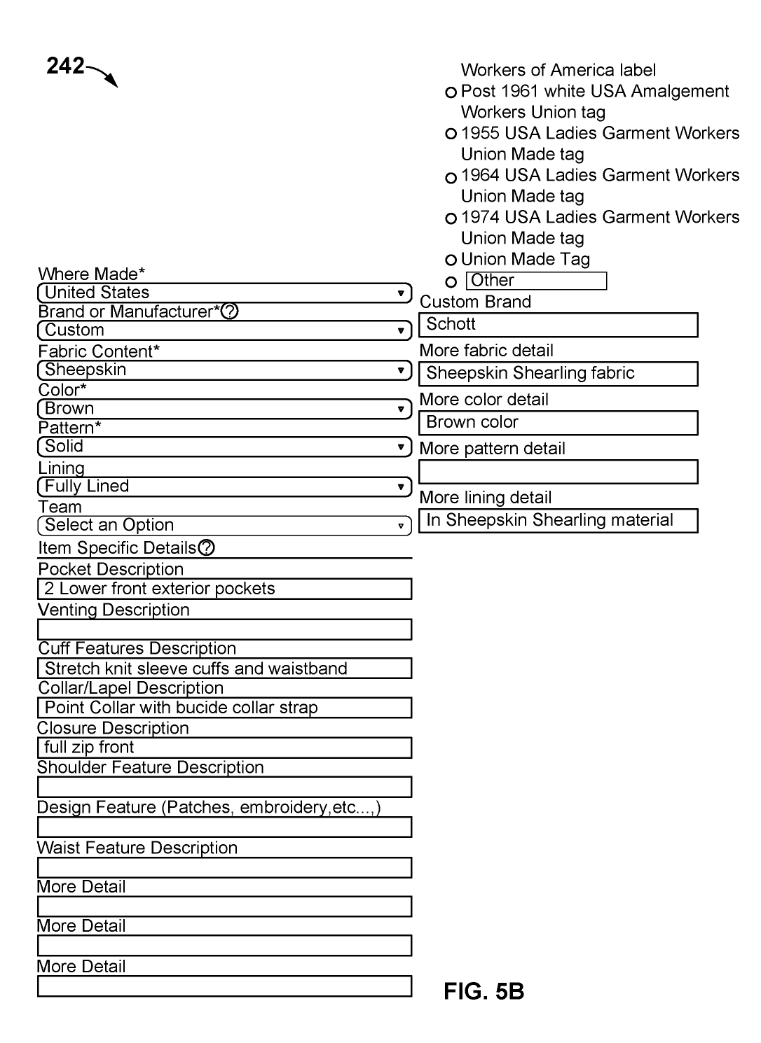

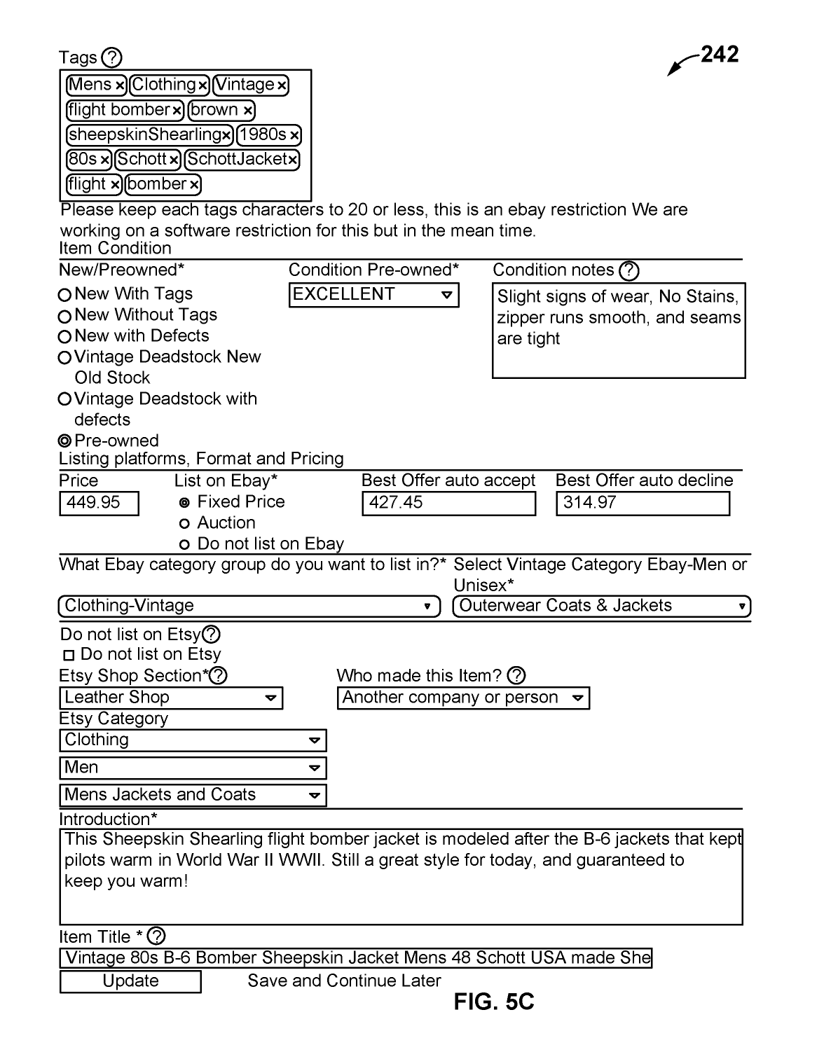

Referring to FIG. 5A-5C, the screenshot of an example form 242 of a product is illustrated. In an example embodiment, the form 242 comprises different options or choices and questions in the form of, but not limited to, radio buttons, drop down boxes, multi-select drop down boxes, text boxes, and or paragraph boxes. The form 242 could also include tag fields, fields that allow for calculations, etc. The options or choices and questions are related to the selected item or product, for example, select template, type of item, gender, category, measurements, size and fittings, specific details of the item, condition, listing platforms, format and pricing, etc. The form 242 shows a single page setup which is preferable, but not limited to, a single page as it could also be divided among 2 or more pages, tab sets, accordion style, or other type of display. In one embodiment, the listing form is specialized by type of item selected by the user, and shows specific questions for the particular item being listed. In one embodiment, the system uses an algorithm to generate forms according to the item type. In one embodiment, the algorithm is conditional logic code.

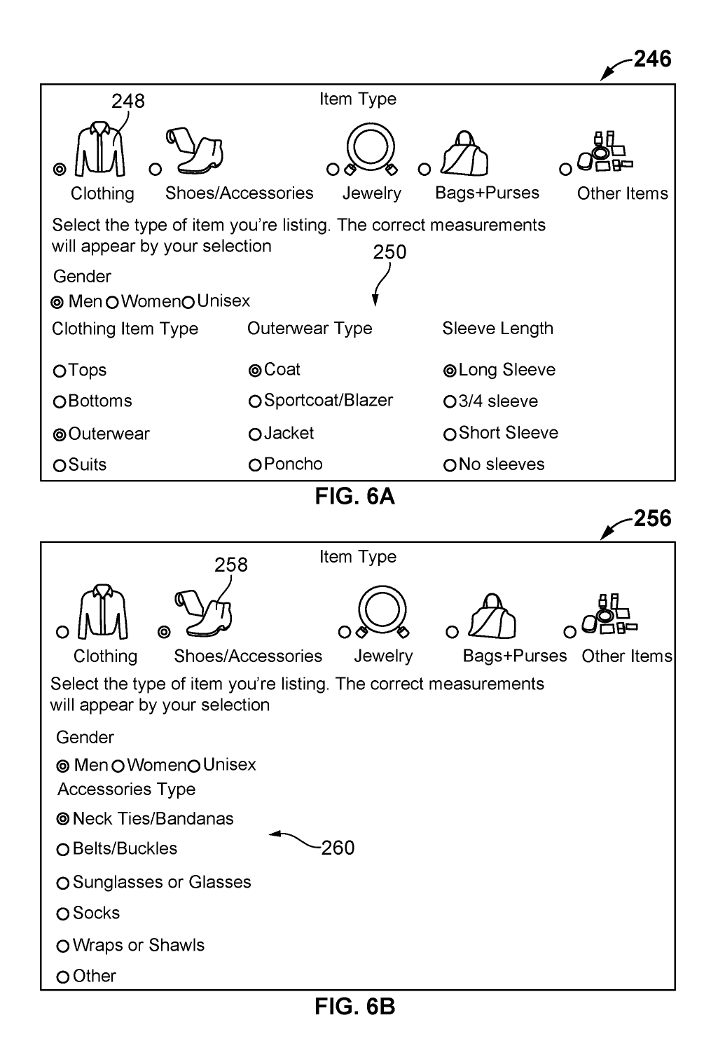

Referring to FIG. 6A, the screenshot 246 of a web page includes a plurality of items with the form 242 is illustrated. In an example embodiment, the screen shot 246 shows that a plurality of items, for example, a clothing 248, shoes/accessories, jewelry, bags and purses, and other items. If the user selects clothing 248, for example a jacket, then the system 106 (shown in FIG. 1) could display a form 250 according to the selection of the user. The user could respond or select the options via the computing device 218. For example, the user could select a jacket 248 from the plurality of items, then the system 106 (shown in FIG. 1) could generate the form 250 according to the selection of the user. In one embodiment, the form 250 includes different questions and options for the user, for example, clothing, gender, clothing item type, outerwear type, and sleeve length, etc. The form 250 also shows fields that could be auto-filled by selecting a template and this could also be filled in separately.

Referring to FIG. 6B, the screenshot 256 of a web page includes a plurality of items with the form 260 is illustrated. For example, if the user selects shoes/accessories 258, then the system 106 (shown in FIG. 1) could display a form 260 according to the selection of the user. The user could respond or select the options via the computing device 218 (shown in FIG. 2). For example, the user could select the shoes/accessories 258 from the plurality of items, then the system 106 (shown in FIG. 1) could generate the form 260 according to the selection of the user. In one exemplary embodiment, the form 260 includes gender, type of item, type of accessories, measurements, etc.

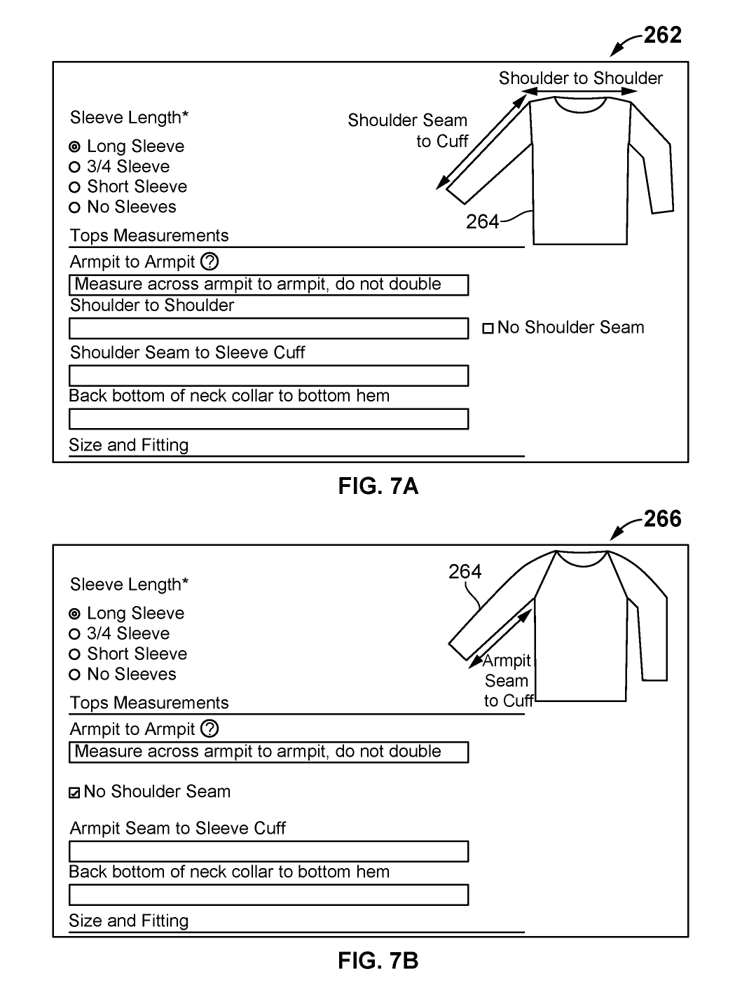

Referring to FIG. 7A, the screenshot 262 of taking measurements of a cloth or jacket 264 with a shoulder seam is illustrated. In one embodiment, the measurements requested for the cloth 264 could have, but not limited to, a shoulder to shoulder measurement, and a shoulder to cuff measurement, where the one without instead requests the armpit seam to sleeve cuff measurement to match the location of the seams. The same principle applies to listing a pair of pants, the measurement fields shown may be waist, inseam, etc. The system 106 (shown in FIG. 1) could also elaborate on this information by specifying if the waist for example is fully stretched when measured, and more. Referring to FIG. 7B, the screenshot 266 of taking measurements of a clothing item or jacket 264 without a shoulder seam is illustrated. In one embodiment, the measurements requested for the clothing item 264 could have, but not limited to, a sleeve length, a shoulder to shoulder measurement, armpit to armpit measurement, a shoulder to cuff measurement, armpit seam to sleeve cuff, and back bottom of neck collar to bottom hem, etc.

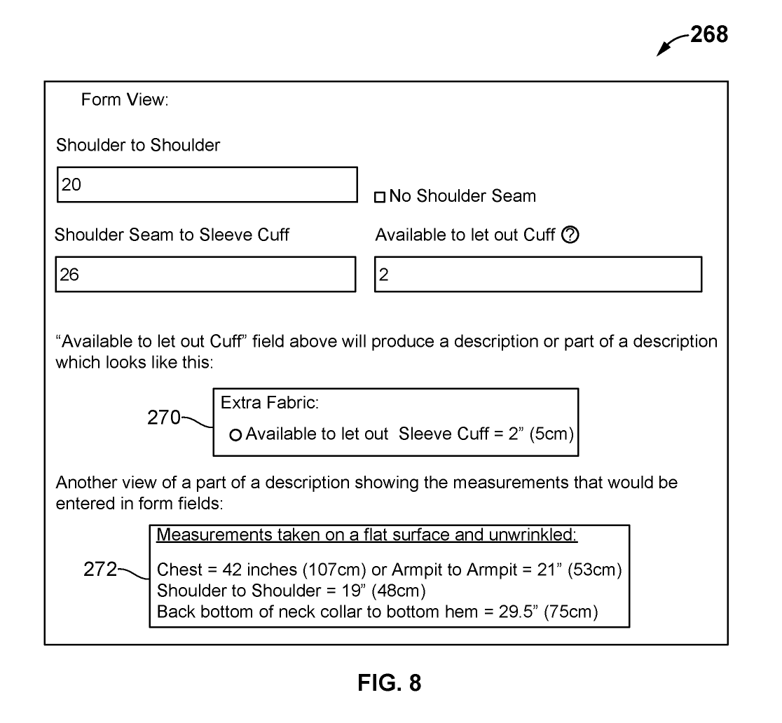

Referring to FIG. 8, the screenshot or snippet 268 of an empty form elements and renderings in description fields is illustrated. In one embodiment, the system 106 (shown in FIG. 1) could estimate how much room is available to make a garment bigger or smaller by how much extra fabric there is, and also include those measurements. The screenshot 268 represents the measurements of the cloth, includes, for example, but not limited to, shoulder to shoulder, shoulder seam to sleeve cuff measurement, and available to let out cuff, etc. The extra fabric or available to let out cuff measurement, of the cloth could be included in the description of the item generated by the system 106 (shown in FIG. 1). In one embodiment, the part of the finished description 270 result might look like when the product is created. In another embodiment, the part of the finished description 272 result might look like when the product is created.

In yet another aspect, the system could programmatically convert weights, measurements and more from imperial to metric or similar type of conversion via the measurement conversion module 212 (shown in FIG. 2) and also optionally include the conversions in the description so international customers benefit by having information relevant to them. This is also important for matching listing or selling platform requirements between platforms. For example, one marketplace may require a listing's weight to be set in all ounces, where listing on another website may require weight to be set as a decimal, and so on. The measurement conversion module 212 (shown in FIG. 2) configured to convert from imperial to metric system or vice versa, and include data right in the description of the item. The conversion could be useful to any customer who uses metric system and doesn't understand imperial weights/measures system. The system 106 (shown in FIG. 1) could calculate the measurement conversions such as, for example, inches to centimeters and include that in listing with no additional input or work from the user. This applies to any item that could be measured laying flat, such as a pair of pants with a waistline; the formula simply doubles that initial measurement to get a waist measurement result.

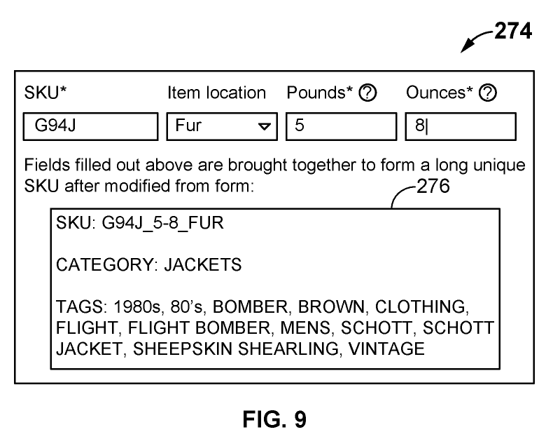

Referring to FIG. 9, the screenshot 274 of an example form elements and renderings in description fields is illustrated. In one embodiment, the screenshot 274 of the form includes, but not limited to, a stock keeping unit (SKU), item location, pounds, ounces, category, and tags, etc. There may be a need to add an SKU in the description field, or there may be a need to elaborate on the SKU and add additional data to it. In one embodiment, the details of the item could be presented in the description of the item generated by the system 106 (shown n FIG. 1). For example, the description 276 includes, the item location and weight are combined in the description.

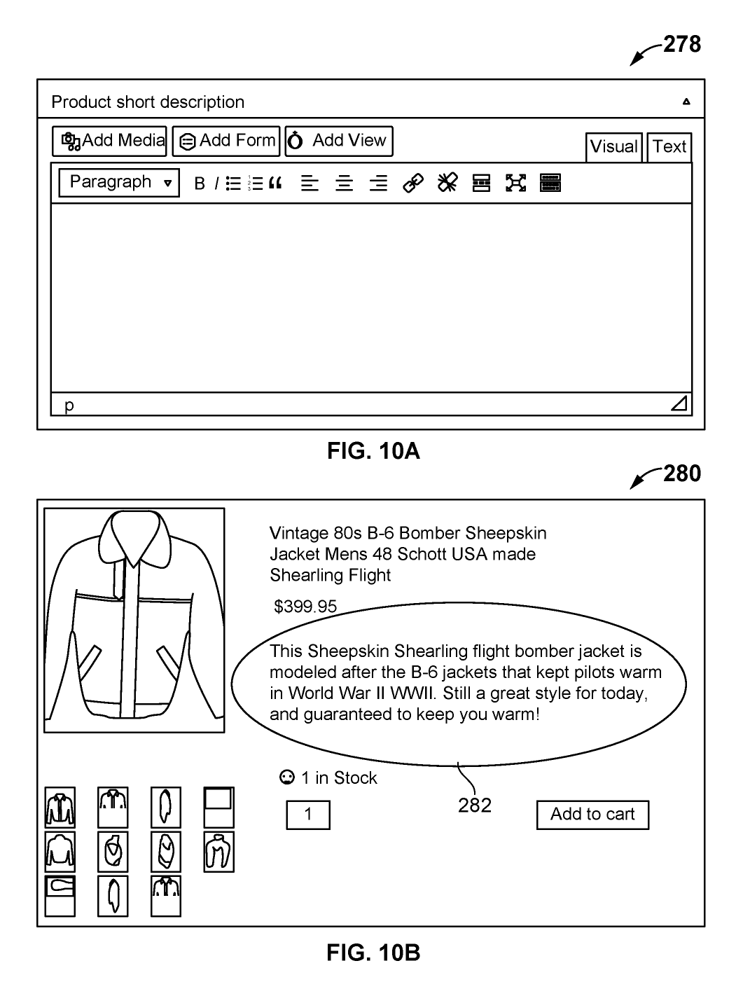

Referring to FIG. 10A, the screenshot 278 of an empty product short description section of a website is illustrated. In one embodiment, the system 106 (shown in FIG. 1) provides a way to add details, for example, but not limited to, default text, graphics, videos or images could be automatically added at any place in the description so it does not need to be manually included by the user when listing. For example, when taking measurements, it is important to show how those measurements are taken and have these instructions adjust by the item type in the listing. For example, a t-shirt will require different measurements than a pair of pants, so the invention could automatically add the correct information that shows how a t-shirt is measured. Referring to FIG. 10B, the screenshot 280 of a product or jacket description section 282 according to the present invention is illustrated. In one embodiment, the system 106 (shown in FIG. 1) could provide short description of the product 282 based on the input given by the user via the form or template form. In one embodiment, the short description of the products 282 describes, but not limited to, type, model, and special features of the product, etc.

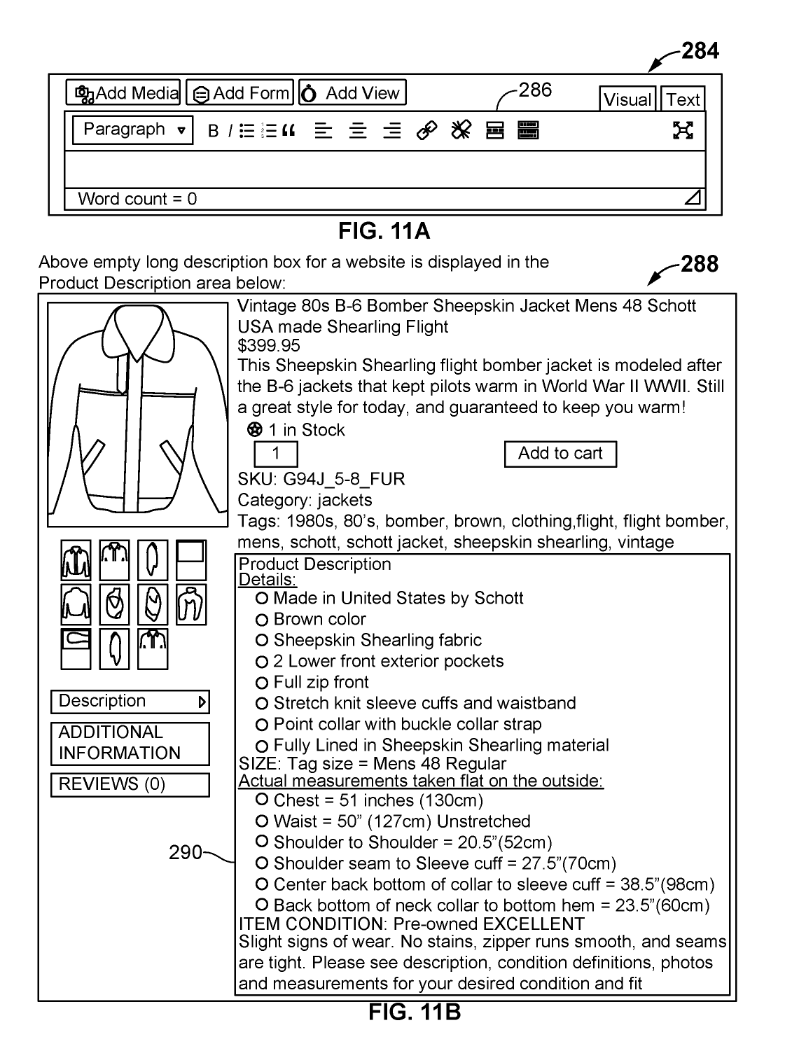

Referring to FIG. 11A, the screenshot 284 of an empty product long description section 286 of a website is illustrated. In one embodiment, the system 106 (shown in FIG. 1) also allows a universal adaptability of the description section 286 which is displayed depending on the listed item. The description of the listed item could be displayed as plain text or with html tags or markup depending on the requirements or limitations of the web or site. When the description field is rendered, it could be displayed in a more visually appealing way by a code such as with bullets, bold face font, etc.

Referring to FIG. 11B, the screenshot 288 of a long description 290 of a product according to the present invention is illustrated. In one embodiment, the system 106 (shown in FIG. 1) automatically generates or creates the product long description 290 based on the user inputs via the user terminal or computing device 218 (shown in FIG. 2). In an exemplary embodiment, the product long description 290, includes, but not limited to, details of the product, size and measurements, and condition of the product, etc. In one embodiment, the description generation module 214 (shown in FIG. 2) is configured to convert the gathered data from the form 242 (shown in FIG. 5A-5C) or a template form into an expanded readable description 290. In one embodiment, the expanded readable description 290 of the product is added in the 242 (shown in FIG. 5A-5C) or a template form via the description generation module 214 (shown in FIG. 2). The user could copy or download the generated expanded readable description 290 via the output module 216 (shown in FIG. 2).

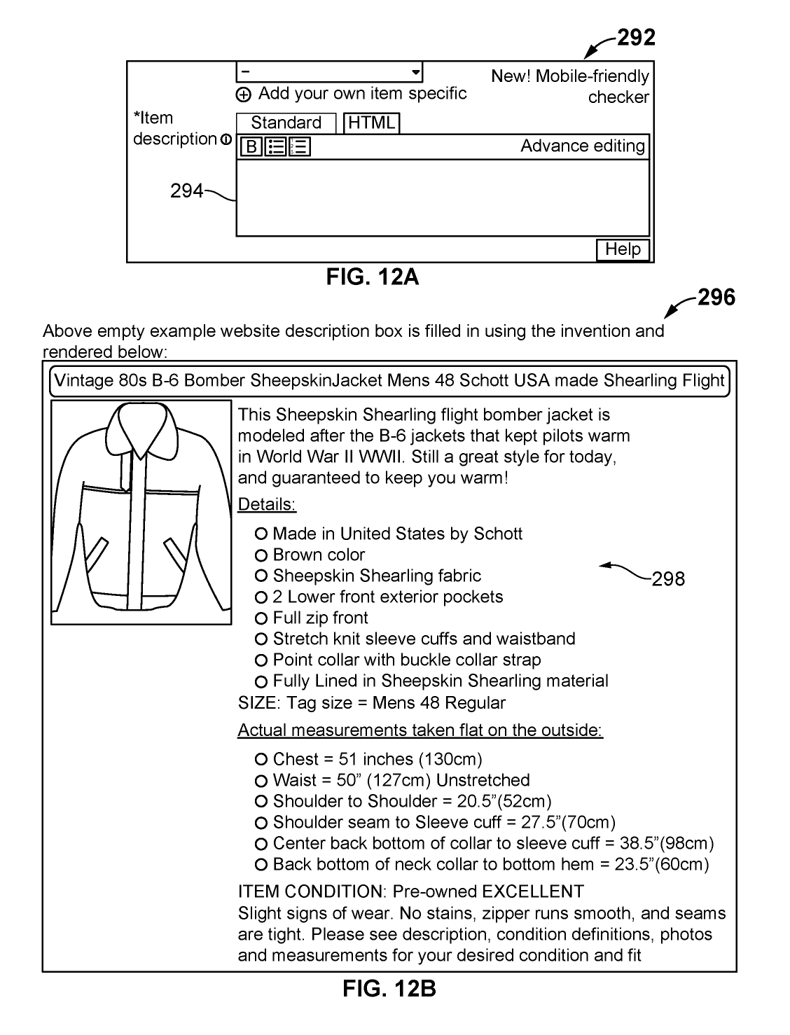

Referring to FIG. 12A, the screenshot 292 of an empty description section or box 294 of the item or product with html markup option of an eBay listing form is illustrated. In one embodiment, the system 106 (shown in FIG. 1) could generate the description of the product with the html markup. Referring to FIG. 12B, the screenshot 296 of a description section or box 298 of the item or product with html markup option of an eBay listing form is illustrated. In one embodiment, the description section or box 298 of the item or product with html markup, includes, but not limited to, bold characters, and images, etc. In one embodiment, the html markup according to the invention could combine both short description and long description of the product. In one embodiment, the description section 298 of the product includes, but not limited to, item listing title, descriptions and tags, size and measurement, type of the product, size and measurements, and item condition, etc. The item listing title, descriptions and tags could help to reach potential buyers, get found in ebay's search, as ebay does not use tags on their site.

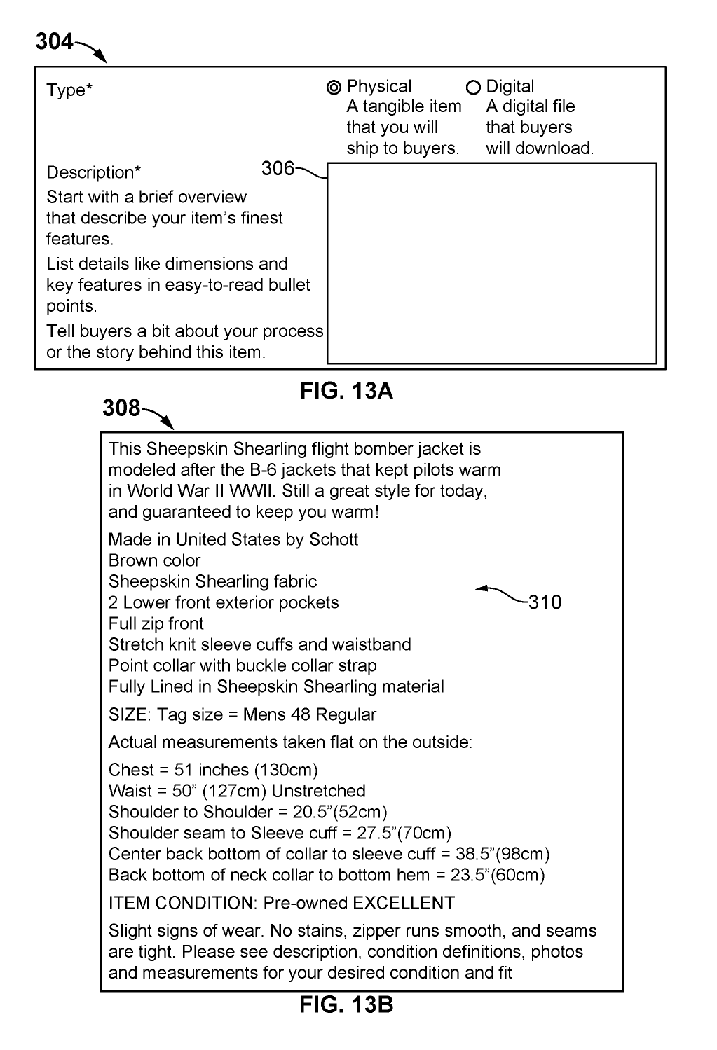

Referring to FIG. 13A, the screenshot 304 of an empty Etsy description section 306 of the product is illustrated. In one embodiment, the system 106 (shown FIG. 1) could also generate the etsy description 306 for the user based on the inputs given in the form or template. Referring to 13B, the screenshot 308 of the etsy description 310 generated by the system 106 (shown in FIG. 1) according to the present invention. In this case, also note there is no html markup or images in the description as these items are not allowed inside the etsy description box, this is automatically done by the system without specification by the user.

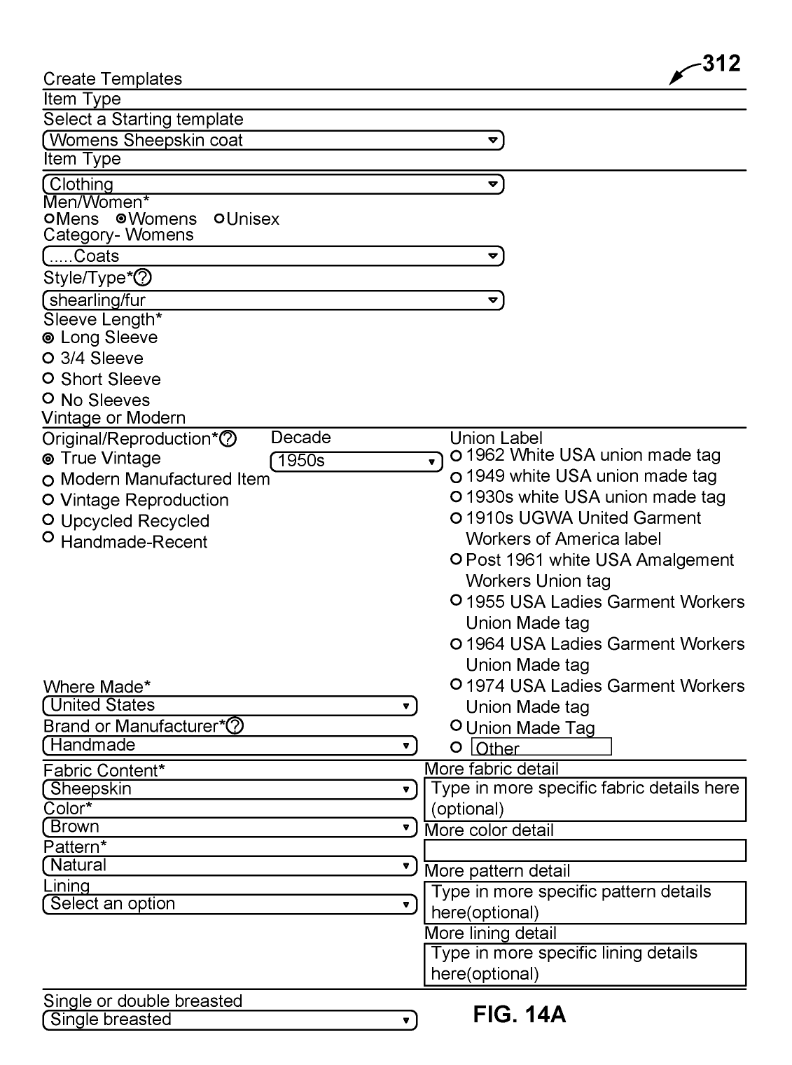

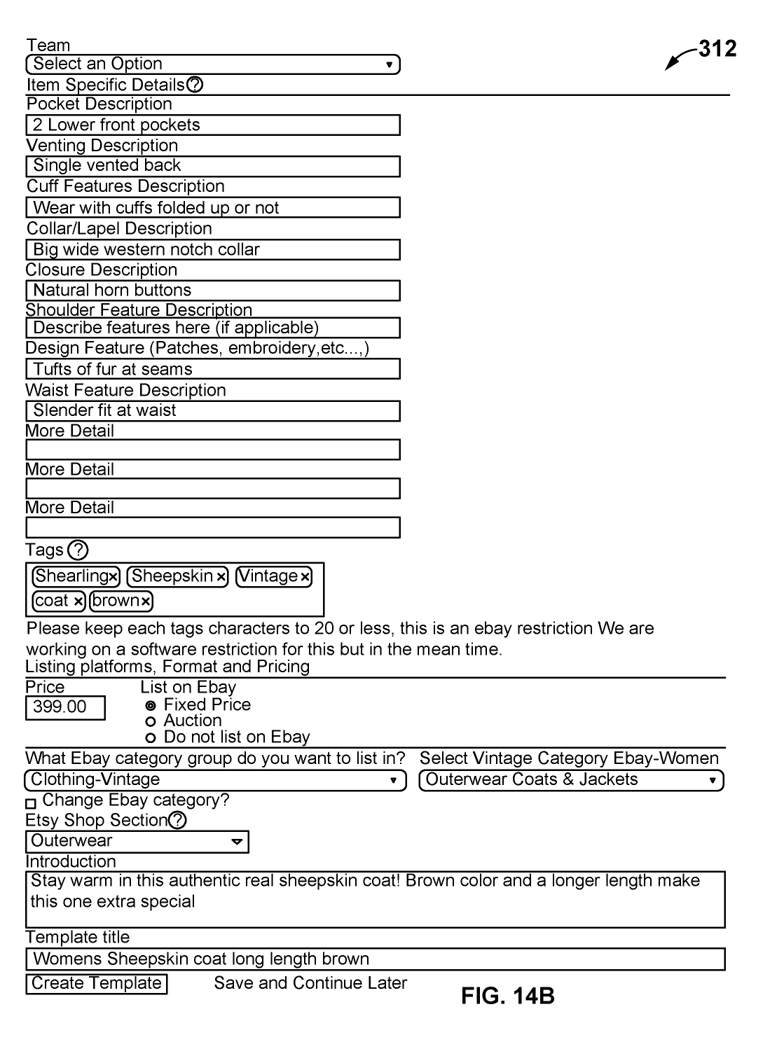

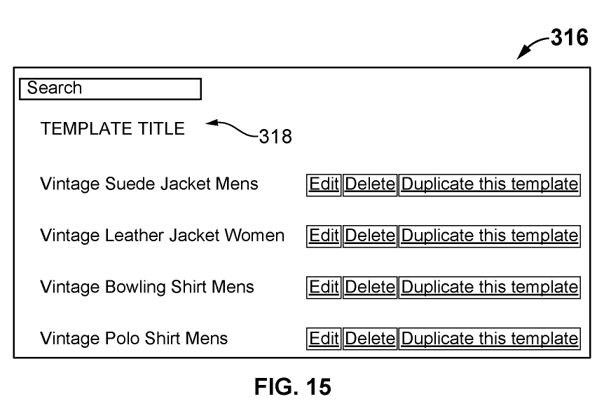

Referring to FIG. 14A-14B, the screenshot of a template form 312 according to the present invention is illustrated. In another embodiment, the system 106 (shown in FIG. 1) also optionally includes a template form 312 that will reduce the inputs required by the user, and also will make the listing form much faster to fill out. In one embodiment, the template form 312 could be pre-made, created or customized by the user so they have total control over them. In one embodiment, template form 312 includes, but not limited to, basic information of the product such as color, fabric, details, categories, measurements, weights, etc. The template form 312 could also include unique details for items such as the historical background, uses for item or other descriptive details. Further, the template form 312 may be selected and used at any point in the listing process, prior to listing an item, while listing an item, or after listing an item. The ability to apply and/or switch a template inside of the same listing questionnaire or form is important because templates could be changed without losing work already done. The fields are consistent so that whatever is filled out in a template field will be transferred to the listing form. Template form 312 could be custom built or pre-defined, drawing from an external template catalog to download or import them to a user's local or personal catalog.

In one embodiment, template form 312 could be created from a product. Any product could become a template. In one embodiment, the implementation of the template form 312 from a product may accomplish by only transferring data from the fields that could be utilized from one product to another, omitting the size, measurements, and other fields. In another implementation, if some or all item specific fields are desired, this also could be possible by the system 106 (shown in FIG. 1).

Referring to FIG. 15, the screenshot 316 of finding and customizing templates 318 by a user is illustrated. In one embodiment, the user could find different templates of the products to provide input to the system 106 (shown in FIG. 1) via the computing device or user terminal 218 (shown in FIG. 2). In one embodiment, each template has different title. Each template is displayed in a row and could be found by the title of the template 318 that was added when created by the user. Each template could be edited, deleted, or used by clicking on the corresponding link.

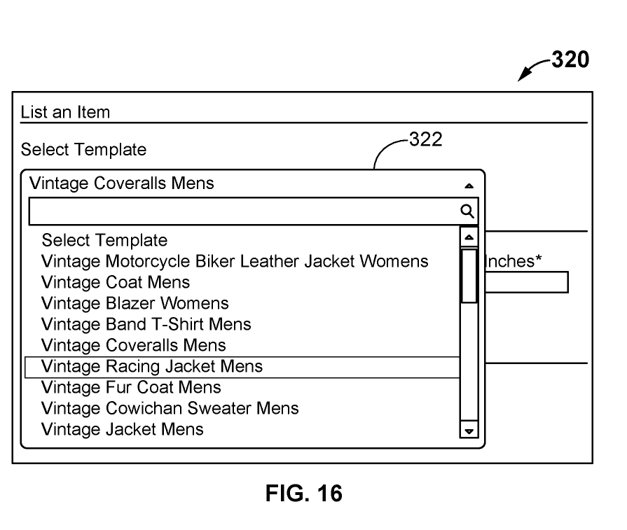

Referring to FIG. 16, the screenshot 320 of template select option 322 according to the present invention is illustrated. In one embodiment, the user could select different templates by the user when creating a new item. The user could use already existing or created templates by their title.

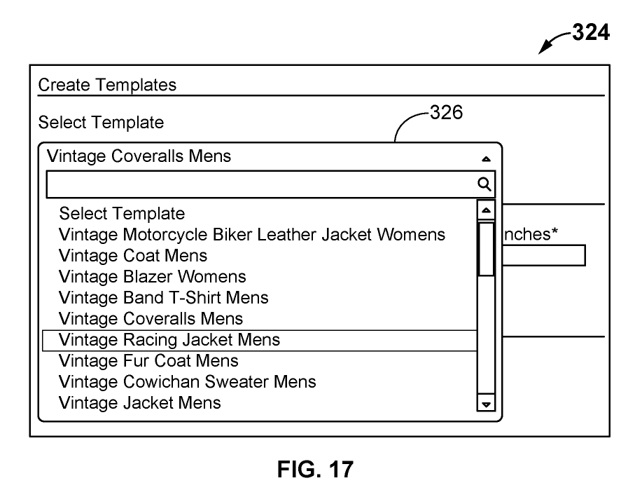

Referring to FIG. 17, the screenshot 324 of a template create option 326 according to the present invention is illustrated. In one embodiment, the user could create a template form based on the selected item or product. In one embodiment, the dropdown with template tittle automatically updates when new templates are created, or old ones deleted. The dropdown in this case is directly embedded in the list of an item form 242 (shown in FIG. 5A-5C) for easy and fast access, but the templates can also be accessed and applied from an external list as shown in figure. Using templates could speed up the process of generating description for the product. In one embodiment, the minimum number of fields filled in for a template is 1, and the maximum are as many as are already configured or as many as the user desires.

The system 106 (shown in FIG. 1) could also have required fields that must be filled out so that important details are not missed. The submission of empty or unanswered required fields will give the user a prompt or notice to fix errors before the data could be submitted, but this may cause an issue if a user only wants to partially fill out the listing form 242 (shown in FIG. 5A-5C) and come back and fill in the rest later. The invention could accommodate that with code that will de-require fields, or use a different form that may merge with the regular listing form when the product is to be completed later, or some other solution.

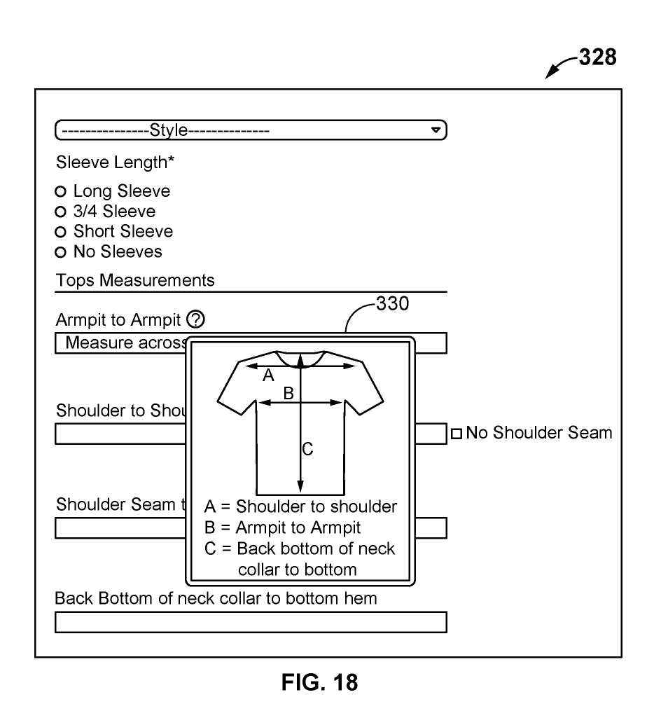

Referring to FIG. 18, the screenshot 328 of list of an item form 330 with images and/or text is illustrated. In one embodiment, the list of an item form 330 with images or text includes, but not limited to, for example, a sleeve length, tops measurements, help bubbles, image of the item or product, etc. In one embodiment, the measurements include shoulder to shoulder, armpit to armpit, etc. of the item and are represented by arrows.

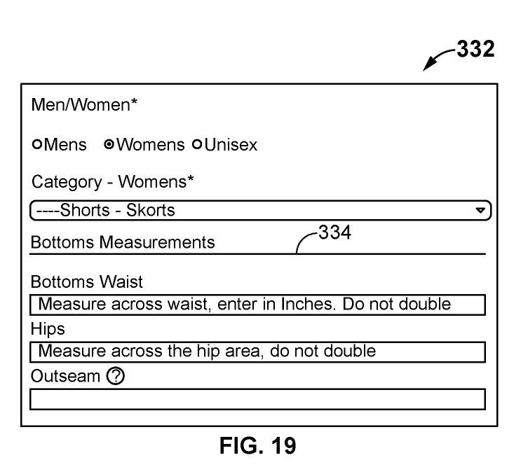

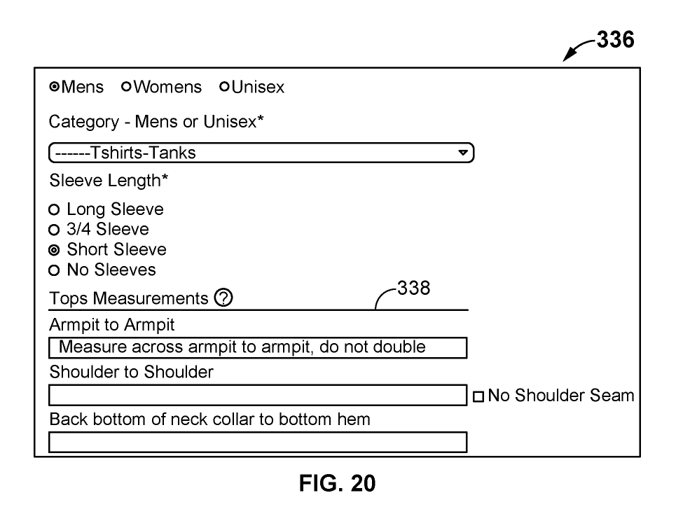

Referring to FIG. 19, the screenshot 332 of an example form 334 for women's shorts is illustrated. In one embodiment, the form 334 represents measurement fields for women's shorts using the algorithm, but not limited to, the conditional logic code. Referring to FIG. 20, the screenshot 336 of an example of form 338 for a men's t-shirt is illustrated. In one embodiment, the example form 338 includes, but not limited to, gender, category, size, measurements, etc.

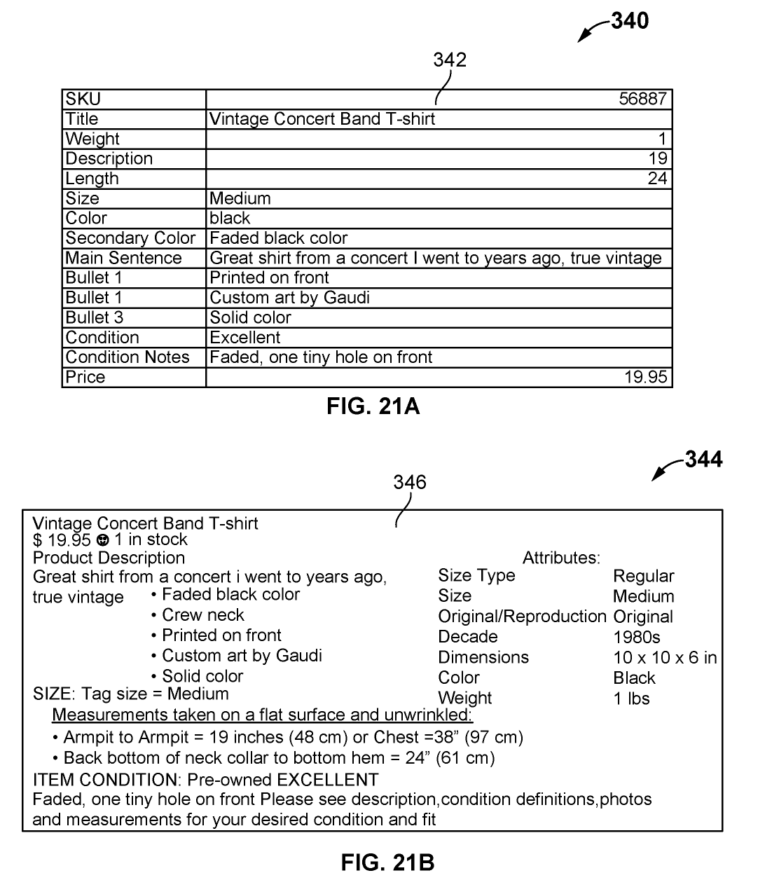

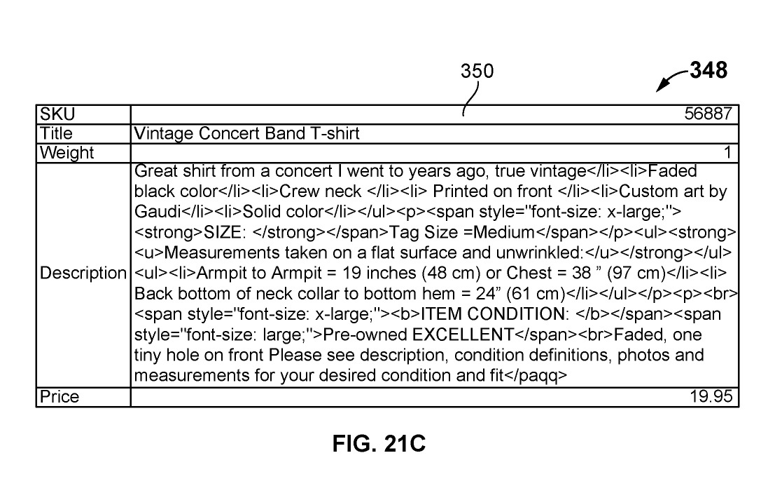

Referring to FIG. 21A, the screenshot 340 of a spreadsheet type data file 342 contains multiple fields is illustrated. In one embodiment, a description could be optionally created by first filling out individual cells in a spreadsheet type data file 342. Referring to FIG. 21B, the screenshot 344 of a product description 346 is illustrated. In one embodiment, the spreadsheet type data file 342 (shown in FIG. 21A) could be received by the system 106 (shown in FIG. 1) for generating complete product description. Referring to FIG. 21C, the screenshot 348 of a completed spreadsheet 350 of the item description with html markup is illustrated. In one embodiment, the created and formatted description along with the attributes could be then downloaded to a spreadsheet file for import to another platform or channel. The new description field which now includes html markup in the completed spreadsheet 350. The last step of downloading the file could be omitted by using, for example, current standard connections to other platforms such as API to push the data over automatically as well.

This type of workflow management could also be used so that low skilled tasks could be completed, and then later someone with high skills could adjust product details locally or remotely without being in the presence of the physical item in an easy and fast way. The user could access the created listing and use their specialized knowledge to adjust templates, and/or add important key words or other details to the listing so that the items or products may sell faster and/or for a higher value. This also applies to a new type of hybrid consignment model that's now available with this invention. Typically, people use one of two ways to offer items for sale online, either list the item themselves or allow a consignor to sell the items. When selling themselves, the owner of the item or consignee lists and sells the item completely on their own using whatever platform they choose, or the consignee leaves the item with a consignor who takes possession of the item and controls every step of the selling process for a high fee.

In the proposed hybrid consignment model, the consignee may want to keep the item in their possession, but may not have the skills or knowledge to sell the item for the highest value possible. The consignee could fill in basic details such as size, measurements and add photos, and the consignor could take care of the remaining parts of the listing process such as researching the item, identifying and applying templates for describing that item with clarity, and/or providing helpful information on how to handle the rest of the selling process so the consignee can do it on their own. This could allow for a win-win for both, the consignee could pay a smaller fee and keep more profits for themselves, and the consignor does not need to handle customer service concerns, store or ship the item, and any other typical issues from consignment.

Although a single embodiment of the invention has been illustrated in the accompanying drawings and described in the above detailed description, it will be understood that the invention is not limited to the embodiment developed herein, but is capable of numerous rearrangements, modifications, substitutions of parts and elements without departing from the spirit and scope of the invention. Further, the description of the item or product generated by the system 106 (shown in FIG. 1) could make their business profitable and these sellers need to be able to complete item listings in as little time as possible, since their profits will rely on the quantity of listings they could produce, the quality these listings have, and/or a combination of both.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A system for creating a description for an information provided by a user, comprising:
a computing device comprising a processor and a memory unit;
a database in communication with the computing device for storing information related to plurality of products and services, and
a user device associated with the user configured to access the computing device via a network,
wherein the memory unit stores a set of program modules, and
wherein the processor in communication with the memory unit, configured to execute the set of program modules, wherein the set of program modules comprises,
an input module configured to receive the information from the user via the user device, wherein the information comprises at least one of a product information, a service information or an information requiring description,
a form creation module configured to present at least one of a form or a template form respective of the received information to the user for gathering data,
a description generation module configured to convert the gathered data into an expanded readable description, and
an output module configured to present the expanded readable description to the user via the user device.

2. The system of claim 1, wherein the program modules further comprises a measurement conversion module configured to convert an imperial measurement received from the user to a metric measurement.

3. The system of claim 1, wherein the output module is configured to enable the user to copy or download the generated readable description.

4. The system of claim 1, wherein the output module is further configured to enable the user to insert the generated readable description into at least one of a product, service, or information online listing.

5. The system of claim 1, wherein the user device is integrated with a graphical display and an audio device to enter the information via at least one of a touch interaction on a display, or voice commands.

6. The system of claim 1, wherein the form comprises one or more fields, questions or prompts for gathering the data, and wherein the template form comprises one or more fields, questions or prompts for gathering the data.

7. The system of claim 1, wherein the readable description comprises images, audio, video and design features.

8. The system of claim 1, wherein the form creation module comprises coded conditional logic to customize the display of the form based on the received information.

9. The system of claim 1, wherein the network is at least one of a Local Area Network, a Wide Area Network, a Wireless Network, a telecommunication network, a mobile network, and an Internet.

10. The system of claim 1, wherein the memory unit is at least one of a volatile memory, non-volatile memory, read only memory (ROM), random access memory (RAM), and a flash memory.

11. The system of claim 1, wherein the user device is at least one of a tablet, personnel computer, personnel digital assistant, smart phone, smart television, palm top, phablet, laptop, or a device with computational capability connected to the internet.

12. A method for creating a description for an information provided by a user, incorporated in the system comprising a computing device with a processor and a memory unit, a database in communication with the computing device for storing a plurality of products and services related information, and a user device configured to access the computing device via a network, comprising the steps of:
receiving at the processor, via an input module, the information from the user via the user device, wherein the information comprises at least one of a product information, a service information or an information requiring description;
presenting at the processor, via a form creation module, at least one of a form or a template form respective of the received information to the user for gathering data;
converting at the processor, via a description generation module, the gathered data into an expanded readable description, and
presenting at the processor, via an output module, the expanded readable description to the user via the user device.

13. The method of claim 12, further comprises a step of: converting at the processor, via a measurement conversion module, an imperial measurement received from the user to a metric measurement.

14. The method of claim 12, wherein the output module is configured to enable the user to copy or download the generated readable description.

15. The method of claim 12, wherein the output module is further configured to enable the user to insert the generated readable description into at least one of a product, service, or information online electronic commerce.

16. The method of claim 12, wherein the user device is integrated with a graphical display and an audio device to enter the information via at least one of touch interactions on a display, or voice commands.

17. The method of claim 12, wherein the form comprises one or more fields, questions or prompts for gathering the data, and wherein the template form comprises one or more fields, questions or prompts for gathering the data.

18. The method of claim 12, wherein the readable description comprises images, audio, video and design features.

19. The method of claim 12, wherein the form creation module comprises coded conditional logic to customize the display of the form based on the received information.
